(19) United States
(12) Patent Application Publication
(10) Pub. No.: US 2018/0015650 A1
(43) Pub. Date: Jan. 18, 2018

(54) Method for applying a void filler

(71) Applicant: LEONARDO S.p.A., Roma (IT)

(72) Inventors: Giancosimo Digiaro, Giovinazzo (IT); Claudio Giagnotti, Barletta (IT); Gianluca Monaco, Foggia (IT); Paolo Acquaviva, Orsara Di Puglia (IT); Domenico Della Martora, Foggia (IT)

(21) Appl. No.: 15/211,851

(22) Filed: Jul. 15, 2016

(51) Int. Cl. B29C 45/14; B29C 45/26; B29L 31/30

(52) U.S. Cl. CPC B29C 45/14336; B29C 45/26; B29K 2995/0026; B29C 2045/14459; B29L 2031/3076; B29C 2045/2683

(57) ABSTRACT

Method for applying a void filler on a surface by means of a mould, wherein the mould comprises a mould body inside which at least one moulding cavity is formed, the moulding cavity being outwardly open at at least one closure surface of the mould, wherein a filler supply duct is further formed inside the mould body, the filler supply duct having a first end to be connected to a filler supply device and a second end in fluid communication with the moulding cavity. The method includes the steps of:
placing the mould on a surface to be sealed in such a way that the closure surface is in contact with the surface to be sealed,
injecting void filler through the filler supply duct until the respective moulding cavity is filled,
allowing the void filler to harden, and removing the mould from the surface thus sealed.

The present invention relates to a method for applying a void filler on a surface to be sealed.

In the aeronautical field and in other industrial sectors, the application of void filler for sealing and filling cavities and joints, or three-dimensional spaces in general, is known.

As is known, the application of the void filler requires the preliminary positioning of a mask to delimit the area to be covered with the sealant.

An adhesion promoter is then applied to the area of application of the void filler, after which the void filler itself is applied by a gun device.

The applied void filler is then shaped with a spatula and left to dry.

This application process has a drawback, in that the dimensional requirements of the sealing cannot be controlled, since the final shape of the seal is created by manual shaping with a spatula, making the finished work approximate and not readily reproducible.

One object of the present invention is to provide a method of applying void filler to a surface which can at least partially overcome the aforementioned drawbacks.

In view of this object, the invention relates to a method for applying a void filler on a surface by means of a mould, wherein the mould comprises a mould body inside which at least one moulding cavity is formed, said moulding cavity being outwardly open at at least one closure surface of the mould, wherein a filler supply duct is further formed inside the mould body, said filler supply duct having a first end to be connected to a filler supply device and a second end in fluid communication with the moulding cavity, and wherein the moulding cavity is outwardly open at opposite ends at a first and a second closure surface respectively, being connected at one end to a through hole, the moulding cavity having a cross section greater than that of the through hole,
said method comprising the steps of:
providing a surface to be sealed comprising a base surface part and a shank surface part projecting from the base surface,
placing the mould on the surface to be sealed in such a way that the first closure surface of the mould is in contact with the shank surface part of the surface to be sealed, and the second closure surface of the mould is in contact with the base surface part of the surface to be sealed, the moulding cavity being arranged around the shank surface part,
injecting void filler through the filler supply duct until the respective moulding cavity is filled,
allowing the void filler to harden, and
removing the mould from the surface thus sealed.

Since the shape of the seal is imparted by the mould, the dimensions of the seal can be determined with certainty. The mould can also provide a better surface finish on the seal.

The presence of the mould also makes it possible to reduce the exposure of the void filler to contamination during and after the injection step.

If the mould body is made of light-transparent material, it is also possible to ascertain whether the area to be sealed is correctly covered before the sealant dries.

Consequently, these improvements over the prior art yield cost savings, for various reasons. In the first place, the sealant material is not wasted, since only the necessary amount is applied. Furthermore, by using a multiple mould it is possible to form a plurality of seals with a single mould. Since the mould is made of anti-adhesive material, it does not have to be cleaned after the process. Finally, the amount of auxiliary materials used for masking is greatly reduced.

Moreover, the non-recurring costs are also reduced, because the mould can be made of low-cost materials that can be processed at high speed using production technology that is readily available on the market.

Specific embodiments of the invention are described in the dependent claims, the content of which is to be considered as an integral part of the present description.

Further characteristics and advantages of the invention will be disclosed more fully in the following detailed description of an embodiment of the invention, provided by way of non-limiting example, with reference to the attached drawings, in which:

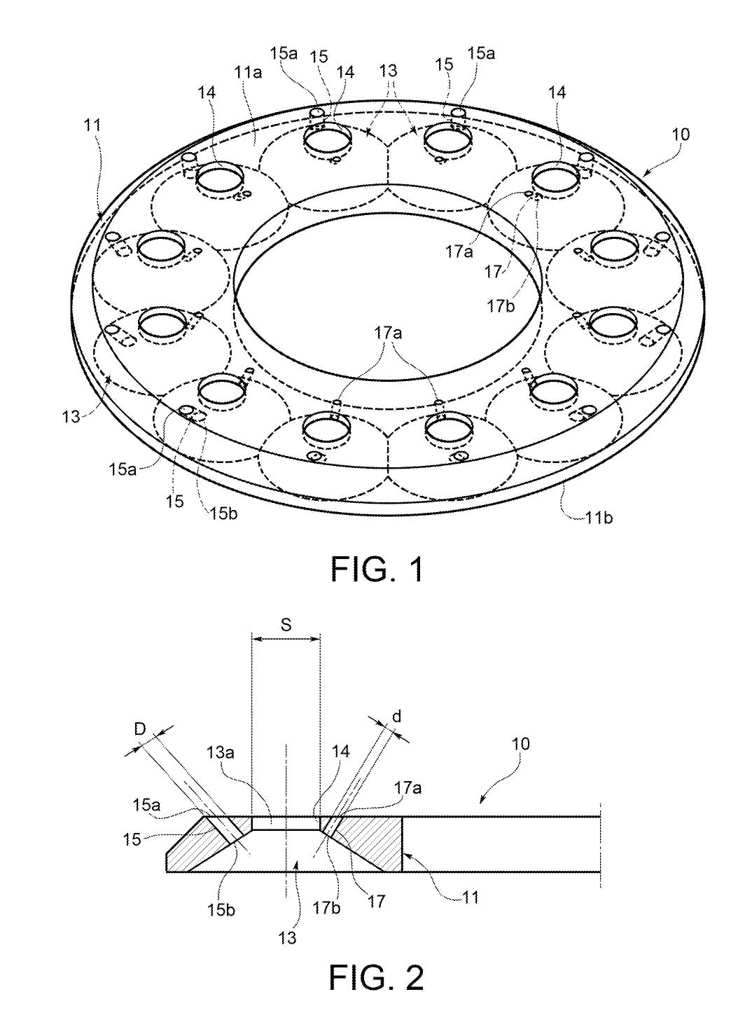

FIG. 1 is a plan view of a mould for the application of void filler;

FIG. 2 is a sectional view of the mould of FIG. 1, taken along a radial plane; and

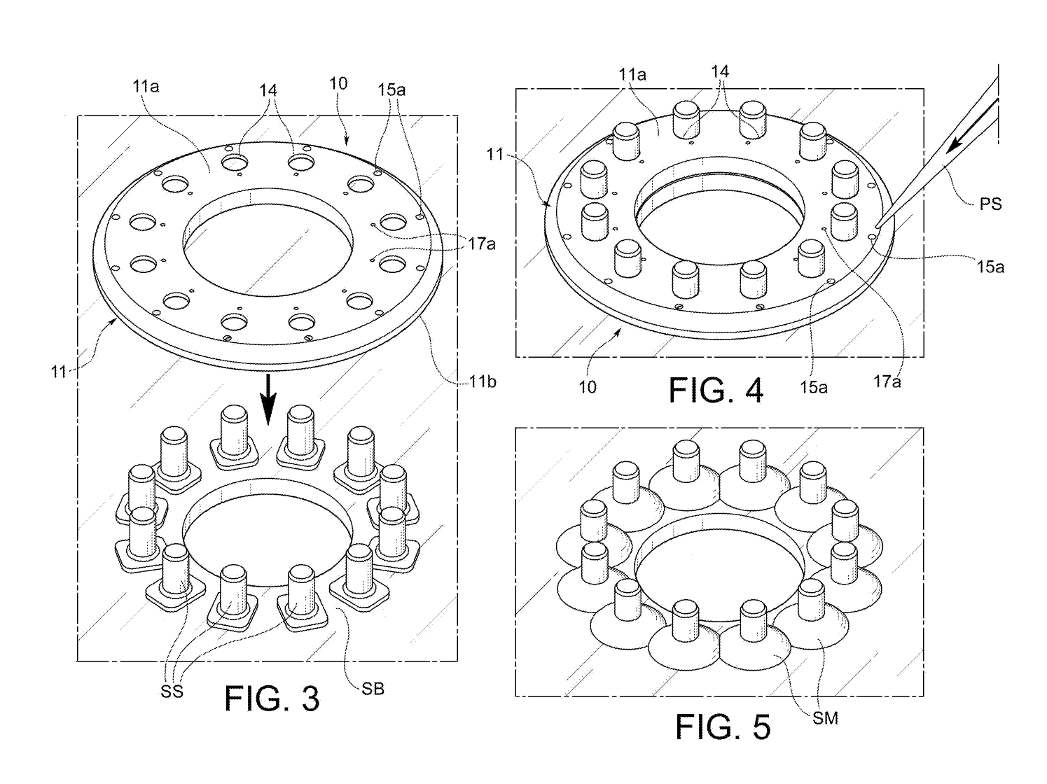

FIGS. 3 to 5 are schematic views representing corresponding operating steps of a method for applying void filler according to the invention.

With reference to FIGS. 1 and 2, a mould for applying void filler according to the invention is illustrated, and is indicated as a whole by 10.

The mould 10 has a mould body 11 of anti-adhesive material, for example polytetrafluoroethylene, in particular the material known by the trade name of Teflon®. Preferably, the material of the mould body 11 is transparent to visible light.

In the illustrated example, the mould body 11 has an annular shape and has a top surface 11a and a bottom surface 11b, on axially opposed sides. In the mould body 11 there is formed a plurality of moulding cavities 13 positioned in a circumferential arrangement, one of which is illustrated individually in the radial sectional view of FIG. 2.

Each moulding cavity 13 is outwardly open at the bottom surface 11b of the mould and at the top surface 11a of the mould.

The moulding cavity 13 is therefore outwardly open at its opposite ends. In the illustrated example, the moulding cavity 13 is connected to a through hole 13a coaxial with the cavity. The cross section of the moulding cavity 13 is larger than the cross section S of the through hole 13a. In particular, the through hole 13a has a cylindrical shape, and is therefore surrounded by a cylindrical surface 14 which is connected to the top surface 11a of the mould; the moulding cavity 13 has a flared shape, and is therefore surrounded by a frustoconical surface, which is connected at one end to the cylindrical surface 14 and at the other end to the bottom surface 11b of the mould.

Inside the mould body 11 there is also formed a filler supply duct 15, separate from the cavity 13 and having a first end 15a (at the top surface 11a of the mould) to be connected to a filler supply device (for example a gun device) and a second end 15b in fluid communication with the moulding cavity 13.

Inside the mould body 11 there is also formed an air vent duct 17, separate from the cavity 13 but in fluid communication therewith, and having a first end 17a which is outwardly open (at the top surface 11a of the mould) and a second end 17b in fluid communication with the moulding cavity 13. As illustrated more clearly in FIG. 2, the air vent duct 17 has a cross section d which is smaller than the cross section D of the filler supply duct 15.

As will now be explained, the cylindrical surface 14 and the bottom surface 11b form closure surfaces of the mould, which can be placed in contact with a surface to be sealed.

With reference to FIG. 3, the mould 10 is placed on a surface to be sealed. This surface may have been treated previously by the application of an adhesion promoter. In the illustrated example, the surface to be sealed belongs to an assembly comprising a panel with a circular opening and through bolts mounted on the panel and arranged circumferentially around the opening. The surface to be sealed therefore comprises a base surface part SB, belonging to the panel, and a plurality of shank surface parts SS, associated with the bolts and therefore projecting from the base surface part SB and positioned in a circumferential arrangement. The arrangement of the moulding cavities 13 on the mould 10 matches the circumferential arrangement of the shank surface parts SS.

When the mould 10 has been placed on the surface to be sealed SB, SS, a first closure surface of the mould, that is to say the cylindrical surface 14 of each moulding cavity 13, is placed in contact with the respective shank surface part SS, and a second closure surface of the mould, that is to say the bottom surface 11b, is placed in contact with the base surface part SB. Each moulding cavity 13 is then positioned around a respective shank surface part SS.

A filler supply device PS, for example a gun device, is then used to inject a void filler through each filler supply duct 15 until the respective moulding cavity 13 is filled (FIG. 4). For the purposes of the present invention, the term “void filler” denotes an adhesive material having a high viscosity and suitable for filling cavities and pores, and three-dimensional spaces in general. During the injection of the void filler, the air present in the moulding cavity 13 is expelled through the air vent duct 17; however, the void filler cannot pass out, or can only pass out with difficulty, through the duct 17, owing to the viscosity of the void filler and the small transverse dimensions of the air vent duct.

The void filler is then left to harden and/or dry, and finally the mould is removed from the surface thus sealed. FIG. 5 shows the sealed surface, with the seals, indicated by SM, applied to the respective bolts. As can be seen, the shape of each individual seal reproduces that of the surface of the moulding cavity by which it was formed, and is therefore regular and practically identical for all the seals SM.

1. Method for applying a void filler on a surface by means of a mould, wherein the mould comprises a mould body inside which at least one moulding cavity is formed, said moulding cavity being outwardly open at at least one closure surface of the mould, wherein a filler supply duct is further formed inside the mould body, said filler supply duct having a first end to be connected to a filler supply device and a second end in fluid communication with the moulding cavity, and wherein the moulding cavity is outwardly open at opposite ends at a first and a second closure surface respectively, being connected at one end to a through hole, the moulding cavity having a cross section greater than that of the through hole,
said method comprising the steps of:
providing a surface to be sealed comprising a base surface part and a shank surface part projecting from the base surface,
placing the mould on the surface to be sealed in such a way that the first closure surface of the mould is in contact with the shank surface part of the surface to be sealed, and the second closure surface of the mould is in contact with the base surface part of the surface to be sealed, the moulding cavity being arranged around the shank surface part, injecting void filler through the filler supply duct to fill the respective moulding cavity,
allowing the void filler to harden, and
removing the mould from the surface thus sealed.

2. Method according to claim 1, wherein an air vent duct is further formed inside the mould body, said air vent duct being in fluid communication with the moulding cavity and having a smaller cross section than that of the filler supply duct.

3. Method according to claim 1, wherein the moulding cavity has a flared shape.

4. Method according to claim 3, wherein the surface to be sealed comprises a plurality of said shank surface parts projecting from the base surface part and positioned in a circumferential arrangement, and wherein the mould comprises a plurality of said moulding cavities positioned in a corresponding circumferential arrangement.

5. Method according to claim 1, wherein the mould body is made of material transparent to visible light.
